(19) United States
(12) Patent Application Publication
(10) Pub. No.: US 2005/0189903 A1
(43) Pub. Date: Sep. 1, 2005

(54) Apparatus for controlling a variable speed motor of a combined belt and disk sander

(75) Inventors: George Ku, Tali City (TW); Eric Lo, Tali City (TW); Bruce Chang, Tali City (TW)

Correspondence Address: NIKOLAI & MERSEREAU, P.A., 900 SECOND AVENUE SOUTH, SUITE 820, MINNEAPOLIS, MN, 55402, US

(73) Assignee: Rexon Industrial Corp., LTD., Tali City (TW)

(21) Appl. No.: 10/847,785

(22) Filed: May 17, 2004

(30) Foreign Application Priority Data
Mar. 1, 2004 (TW) 093203016

(51) Int. Cl. H02P 7/36

(52) U.S. Cl. 318/807

(57) ABSTRACT

An apparatus for controlling a variable speed motor of a combined belt and disk sander includes a drive circuit, an inverter circuit, a current detection device, a transducer and a control circuit. The drive circuit produces variable frequency square pulses. The inverter circuit utilizes the square pulses to produce a variable frequency voltage to drive the motor at variable speeds. The current detection device detects any current changes in the motor and returns a feedback current to the control circuit. The transducer provides a variable resistance connected to the control circuit so a person can set a desired speed of the motor by adjusting the transducer. The control circuit controls the frequency of the square pulses sent by the drive circuit to control the variable speed of the motor.

### BACKGROUND OF THE INVENTION

1. Field of the Invention

The present invention relates to a control means for motor speed, and more particularly to an apparatus to control a variable speed motor of a combined belt and disk sander.

2. Description of Related Art

Combined belt and disk sanders are extensively used to condition surfaces of objects and are convenient to use because a combined belt and disk sander can sand in either horizontal or vertical directions. A combined belt and disk sander comprises a housing, a belt sander, a disk sander and a drive motor. The housing has a top surface and a side surface. The belt sander is a continuous abrasive belt, is mounted across the top surface of the housing and is rotated to sand in a horizontal direction. The disk sander is mounted on the side surface of the housing and is rotated to sand in a vertical direction. The drive motor is mounted in the housing and rotates both the belt and the disk sanders.

However, speed of the drive motor of the combined belt and disk sander in accordance with the prior art cannot be varied. The speed of the motor of the conventional combined belt and disk sander is constant, which cannot be adjusted to accommodate sanding different kinds of objects. Because mechanical and physical properties of different objects are quite different, to condition the surfaces of different objects requires an appropriate speed of the belt or the disk sanders to obtain a great surface.

To overcome the shortcomings, the present invention provides an apparatus to control speed of the motor in the combined disk and belt sander to mitigate or obviate the aforementioned problems.

### SUMMARY OF THE INVENTION

The main objective of the invention is to provide an apparatus to vary speed of a motor in a combined belt and disk sander to accommodate sanding various objects.

An apparatus in accordance with the present invention to vary speed of a motor in a combined belt and disk sander includes a drive circuit, an inverter circuit, a current detection device, a transducer and a control circuit. The drive circuit is used to produce variable frequency square pulses. The inverter circuit utilizes the square pulses to produce variable frequency voltage to drive the motor at variable speeds. The current detection device detects the current changes in the motor and returns a feedback current to the control circuit. The transducer provides a variable resistance coupled to the control circuit so that a person can set a desired speed of the motor by adjusting the transducer. The control circuit controls the frequency of the square pulses sent by the drive circuit to vary the speed of the motor.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a combined disk and belt sander with a speed control apparatus in accordance with the present invention; and

FIG. 2 is a circuit diagram of the speed control apparatus in accordance with the present invention.

### DETAILED DESCRIPTION OF PREFERRED EMBODIMENT

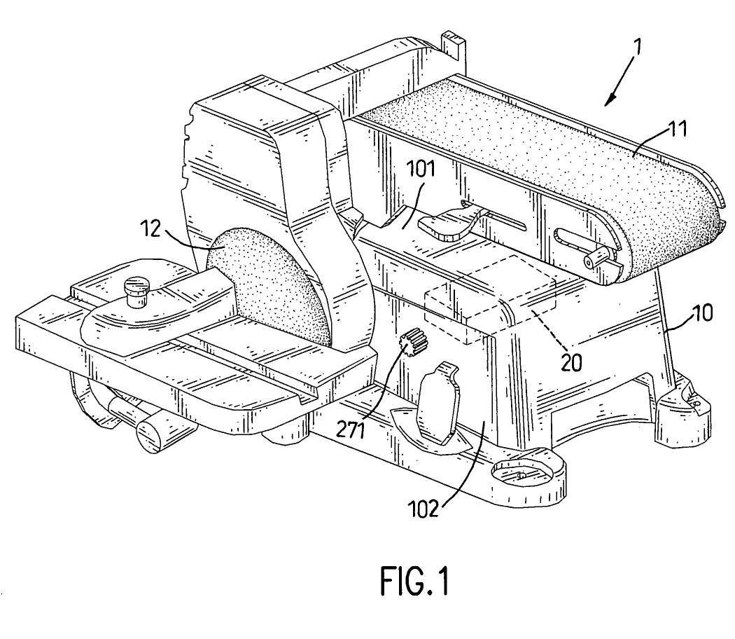

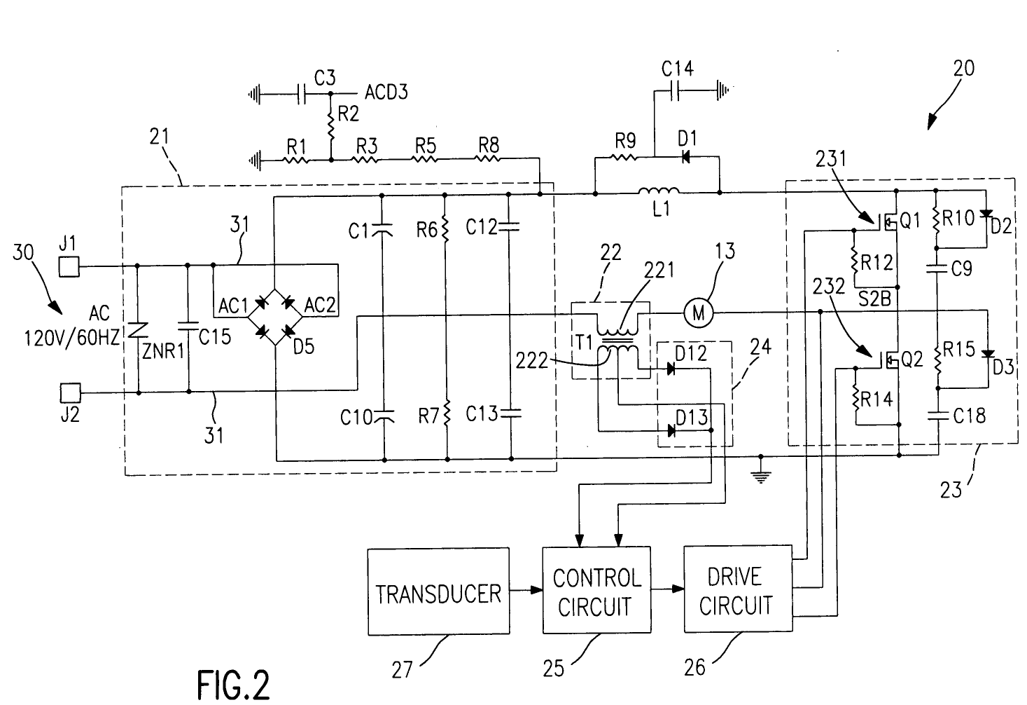

With reference to FIGS. 1 and 2, a combined belt and disk sander (1) in accordance with the present invention comprises a housing (10), a belt sander (11), a disk sander (12), a motor (13) and a speed control apparatus (20). The housing (10) has a top surface (101) and a side surface (102). The belt sander (11) is mounted across the top surface (101) to provide a capability to sand in a horizontal direction. The disk sander (12) is mounted at the side surface (102) to provide a capability to sand in a vertical direction. The motor (13) has a stator, can be an induction motor, is mounted in the housing (10) and rotates both the belt sander (11) and the disk sander (12).

The speed control apparatus (20) is connected to both an AC power source (30) and the motor (13) to drive the motor (13) at various speeds. The speed control apparatus (20) comprises a front-end converter (21), a current detection device (22), an inverter circuit (23), a current rectifier (24), a control circuit (25), a drive circuit (26) and a transducer (27).

The front-end converter (21) is connected to the AC power source (30) through wires (31), where the number of the wires (31) is equal to phases of the alternating current. The front-end converter (21) is used to convert the alternating current to direct current that drives the inverter circuit (23). The front-end converter (21) generates voltages to rotate the motor (13) at desired speeds.

The current detection device (22) may be a current transformer and is connected between the AC power source (30) and the motor (13) to detect current changes in the stator of the motor (13). The current detection device (22) comprises a primary winding (221) and a secondary winding (222). The primary winding (221) is connected to one of the wires (31) and the stator of the motor (13). The secondary winding (222) is connected to the current rectifier (24) and is induced by the primary winding (221). The wire (31) transmits alternating current through the primary winding (221) to drive the motor (13). Therefore, the alternating current in the primary winding (221) will induce a corresponding current in the secondary winding (222). The corresponding current in the secondary winding (222) is returned to the control circuit (25) through the current rectifier (24) so that the current changes in the stator of the motor (13) will be known by the control circuit (25).

The current rectifier (24) can be a full-wave rectifier and converts the induced corresponding current in the secondary winding (222) to a DC feedback current. The feedback current is sent to the control circuit (25).

The control circuit (25) receives the feedback current, is connected to the transducer (27) and may be a microcontroller that serves as a closed-loop servo control system. The control circuit (25) is programmable and comprises nonvolatile memory devices to store program code, also known as firmware. The program code is stored in the nonvolatile memory devices and depends on the needs of the motor speed control.

The transducer (27) may be a potentiometer and has an external control knob (271) and an internal variable resistance. The external control knob (271) is mounted on the side surface (102) of the housing so that a person can turn the external control knob (271) and change the variable resistance to the control circuit (25) to set a desired speed of the motor (13). The transducer (27) is connected to the control circuit (25).

The control circuit (25) sends a command signal based on the desired speed set by the transducer (27) to the drive circuit (26). The drive circuit (26) produces variable frequency voltage pulses in a square waveform to vary the speed of the motor (13) to the desired speed. The drive circuit (26) can utilize sinusoidal pulses-width modulation (SPWM) to produce the square voltage pulses as driving signals. A skilled person in this art knows the basic principles of SPWM. SPWM uses a high-frequency triangular wave as a carrier and a desired reference waveform, and a sinusoidal wave to generate desired square voltage pulses by comparing the carrier to the reference waveform.

The inverter circuit (23) may be a half-bridge voltage inverter that comprises a first and a second switching element (231, 232). The inverter circuit (23) is connected to the motor (13) and receives the square voltage pulses sent by the drive circuit (26). The switching elements (231, 232) turn on and off alternatively in response to the frequency of the received square voltage pulses generated by the SPWM that converts the DC voltage to a variable frequency AC voltage that drives the motor (13) at variable speeds.

Since the output speed of the motor (13) is proportional to the voltage frequency in the stator, varying the frequency of the input voltage to the motor (13) will change the speed of the motor (13). The changes of the current in the stator in the motor (13) are detected by the current detection device (22) and are sent as feedback signals to the control circuit (25). The control circuit (25) acts as a closed-loop servo control system to control the motor (13) at variable speeds. The control circuit (25) causes the drive circuit (26) to generate variable frequency voltage pulses for the inverter circuit (23) to generate a variable frequency voltage to drive the motor (13) so that the speed of the motor (13) can be varied and accurately controlled.

Furthermore, the motor (13) rotates the belt sander (11) and the disk sander (12). If sanding debris or small pieces jam the belt sander (11) and the disk sander (12), the current in the stator winding of the motor (13) will increase. The control circuit (25) will stop the motor (13) to prevent current saturation in the motor (13) by the detection of the current detection device (22) to protect the motor (13) from damage.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the scope of the appended claims.

1. An apparatus for controlling a variable speed motor of a combined belt and disk sander, and the apparatus comprising:
a drive circuit to produce variable frequency square pulses;
a control circuit connected to the drive circuit to produce the variable frequency square pulses;
an inverter circuit connected to the drive circuit, to receive the square pulses and use the square pulses to produce a driving signal to drive the motor at variable speeds;
a current detection device connected to the motor to detect current changes in the motor and return a feedback current to the control circuit; and
a transducer providing a variable resistance connected to the control circuit;
wherein the transducer is used to set a desired speed, the driving signal has a frequency that varies and corresponds to the frequency of the square pulses to adjust the motor speed, and the control circuit controls the frequency of the square pulses whereby the motor rotates at a desired speed.

2. The apparatus as claimed in claim 1, wherein the drive circuit utilizes sinusoidal pulses-width modulation (SPWM) to produce the square pulses.

3. The apparatus as claimed in claim 1, wherein the inverter circuit is a half-bridge voltage inverter.

4. The apparatus as claimed in claim 1, wherein the current detection device is a current transformer.

5. The apparatus as claimed in claim 1, wherein the transducer is a potentiometer.

6. The apparatus as claimed in claim 1 further comprising a front-end converter connected to and driving the inverter circuit.

7. The apparatus as claimed in claim 1 further comprising a full-wave rectifier connected between the current detection device and the control circuit.

8. The apparatus as claimed in claim 1, wherein the control circuit receives the feedback current to serve as a closed-loop servo control system.

9. The apparatus as claimed in claim 1, wherein the control circuit is a microcontroller.
